(19) United States
(12) Patent Application Publication
(10) Pub. No.: US 2013/0140265 A1
(43) Pub. Date: Jun. 6, 2013

(54) METHODS OF FORMING PATTERN STRUCTURES AND METHODS OF FORMING CAPACITORS USING THE SAME

(71) Applicants: Cheon-Bae KIM, Gyeonggi-do (KR); Kyu-Pil LEE, Gyeonggi-do (KR); Chang-Hyun CHO, Gyeonggi-do (KR); Gyo-Young JIN, Seoul (KR)

(72) Inventors: Cheon-Bae KIM, Gyeonggi-do (KR); Kyu-Pil LEE, Gyeonggi-do (KR); Chang-Hyun CHO, Gyeonggi-do (KR); Gyo-Young JIN, Seoul (KR)

(21) Appl. No.: 13/608,232

(22) Filed: Sep. 10, 2012

(30) Foreign Application Priority Data
Dec. 6, 2011 (KR) 10-2011-0129380

(51) Int. Cl. H01G 9/00; B44C 1/22

(52) U.S. Cl. 216/6; 216/40

(57) ABSTRACT

A method of manufacturing a pattern structure, the method includes sequentially forming a mold layer and a mask layer on a substrate, patterning the mask layer to form a mask having a plurality of first and second holes located at vertices of hexagons that form a honeycomb structure, forming filling layer patterns in the first and second holes, removing the mask, forming a spacer on sidewalls of the filling layer patterns and the spacer has a plurality of third holes at centers of the hexagons, removing the filling layer patterns to form an etching mask including the spacer, and etching the mold layer using the etching mask to form the pattern structure having a plurality of openings located at the vertices and the centers of the hexagons.

### CROSS-REFERENCE TO RELATED APPLICATION

This application claims priority under 35 USC §119 to Korean Patent Application No. 10-2011-0129380, filed on Dec. 6, 2011, in the Korean Intellectual Property Office, and entitled “Methods of Forming Pattern Structures and Method of Forming Capacitors Using the Same,” which is incorporated by reference herein in its entirety.

### BACKGROUND

As semiconductor devices have been highly integrated, openings or patterns may be formed very closely, and the size of the openings or patterns may decrease.

### SUMMARY

Embodiments may be realized by providing a method of manufacturing a pattern structure that includes sequentially forming a mold layer and a mask layer on a substrate, patterning the mask layer to form a mask having a plurality of first and second holes located at vertices of hexagons that form a honeycomb structure, forming filling layer patterns in the first and second holes, removing the mask, forming a spacer on sidewalls of the filling layer patterns and the spacer has a plurality of third holes at centers of the hexagons, removing the filling layer patterns to form an etching mask including the spacer, and etching the mold layer using the etching mask to form the pattern structure having a plurality of openings located at the vertices and the centers of the hexagons.

A size of the third holes may be controlled by a thickness of the spacer. The method may include forming a hard mask layer between the mold layer and the mask layer. The mask may be formed by performing a photolithography process twice.

Forming the mask may include performing a first photolithography process on the mask layer to form a preliminary mask having the first holes at odd numbered vertices of the hexagons, and performing a second photolithography process on the preliminary mask to form the mask having the second holes at even numbered vertices of the hexagons in addition to the first holes. Forming the spacer may include forming a spacer layer on the filling layer patterns and the mold layer, and anisotropically etching the spacer layer.

Embodiments may also be realized by providing a method of manufacturing a capacitor that includes manufacturing the pattern structure, wherein the honeycomb structure is a first honeycomb structure having first hexagons including first vertices and first centers, forming a plurality of lower electrodes in the openings, sequentially forming a dielectric layer and an upper electrode on the lower electrodes, and forming pad electrodes on the substrate prior to manufacturing the pattern structure. The pad electrodes are arranged at second vertices and second centers of second hexagons that form a second honeycomb structure.

Forming the pad electrodes may include forming a sacrificial layer on the substrate, patterning the sacrificial layer to form a sacrificial layer pattern having a plurality of fourth and fifth holes located at the first vertices of the first hexagons forming the first honeycomb structure, forming first and second pad electrodes in the fourth and fifth holes, respectively, removing the sacrificial layer pattern, forming a second spacer on sidewalls of the first and second pad electrodes and the second spacer has a plurality of sixth holes at the first centers of the first hexagons, and forming third pad electrodes in the sixth holes.

A size of the third holes may be controlled by a thickness of the spacer. The method may include forming an etch stop layer on the pad electrodes. The method may include removing the mold layer to expose sidewalls of the lower electrodes after forming the lower electrodes. Patterning the mask layer may include performing a photolithography process twice.

Embodiments may also be realized by providing a method of manufacturing a pattern structure that includes forming a sacrificial layer on a substrate, patterning the sacrificial layer to form a sacrificial layer pattern having a plurality of first and second holes located at vertices of hexagons that form a honeycomb structure, forming first and second conductive layers in the first and second holes, respectively, removing the sacrificial layer pattern, forming a spacer on sidewalls of the first and second conductive layers and the spacer has a plurality of third holes at centers of the hexagons, and forming third conductive layers in the third holes.

The sacrificial layer pattern may be formed by performing a photolithography process twice. Forming the sacrificial layer pattern may include performing a first photolithography process on the sacrificial layer to form a preliminary sacrificial layer pattern having the first holes at odd numbered vertices of the hexagons, and performing a second photolithography process on the preliminary sacrificial layer pattern to form the sacrificial layer pattern having the second holes at even numbered vertices of the hexagons in addition to the first holes.

Embodiments may also be realized by providing a method of manufacturing a pattern structure that includes forming a mask layer on a substrate and the mask layer includes a plurality of first and second holes corresponding to vertices of hexagons, filling the first and second holes of the mask layer, removing the mask layer after filling the first and second holes such that filling layer patterns corresponding to the first and second holes remain on the substrate, forming a spacer covering sidewalls of the filling layer patterns and the spacer includes third holes therein, removing the filling layer patterns such that the spacer remains on the substrate to form an etching mask having a honeycomb structure, and forming the pattern structure using the etching mask.

The etching mask may have a plurality of openings corresponding to the first, the second, and the third holes, respectively, and the plurality of openings may be spaced apart from each other. A photolithography process may only be performed twice to form the etching mask.

The photolithography process may include a first photolithography process that forms the first holes and a second photolithography process that forms the second holes. The third holes may correspond to centers of the hexagons. The centers of the hexagons being spaced apart from the vertices of the hexagons in the honeycomb structure.

### BRIEF DESCRIPTION OF THE DRAWINGS

Features will become apparent to those of ordinary skill in the art by describing in detail exemplary embodiments with reference to the attached drawings in which:

FIG. 1A illustrates a cross-sectional view of a pattern structure in accordance with example embodiments;

FIG. 1B illustrates a plan view of the pattern structure of FIG. 1A;

FIGS. 2, 3A, 4A, 5, 6A, 7A, 8A, to 9A illustrate cross-sectional views depicting stages in a method of forming a pattern structure in accordance with example embodiments;

FIGS. 3B, 4B, 6B, 7B, 8B, and 9B illustrate plan views depicting stages in the method of forming the pattern structure;

FIG. 10A illustrates a cross-sectional view of a pattern structure in accordance with example embodiments;

FIG. 10B illustrates a plan view of the pattern structure in FIG. 10A. Particularly, FIG. 10A illustrates a cross-sectional view cut along the line B-B′ in FIG. 10B;

FIGS. 11A, 12A, 13A, and 14A illustrate cross-sectional views depicting stages in a method of forming a pattern structure in accordance with example embodiments;

FIGS. 11B, 12B, 13B, and 14B illustrate plan views of the method of forming the pattern structure;

FIG. 15 illustrates a cross-sectional view of capacitors in accordance with example embodiments; and

FIGS. 16 to 19 illustrate cross-sectional views depicting stages in a method of forming capacitors in accordance with example embodiments.

### DETAILED DESCRIPTION OF THE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the drawings, the sizes and relative sizes of layers and regions may be exaggerated for clarity. Example embodiments are described herein with reference to cross-sectional illustrations that are schematic illustrations of idealized example embodiments (and intermediate structures). As such, variations from the shapes of the illustrations as a result, e.g., of manufacturing techniques and/or tolerances, are to be expected. Thus, example embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

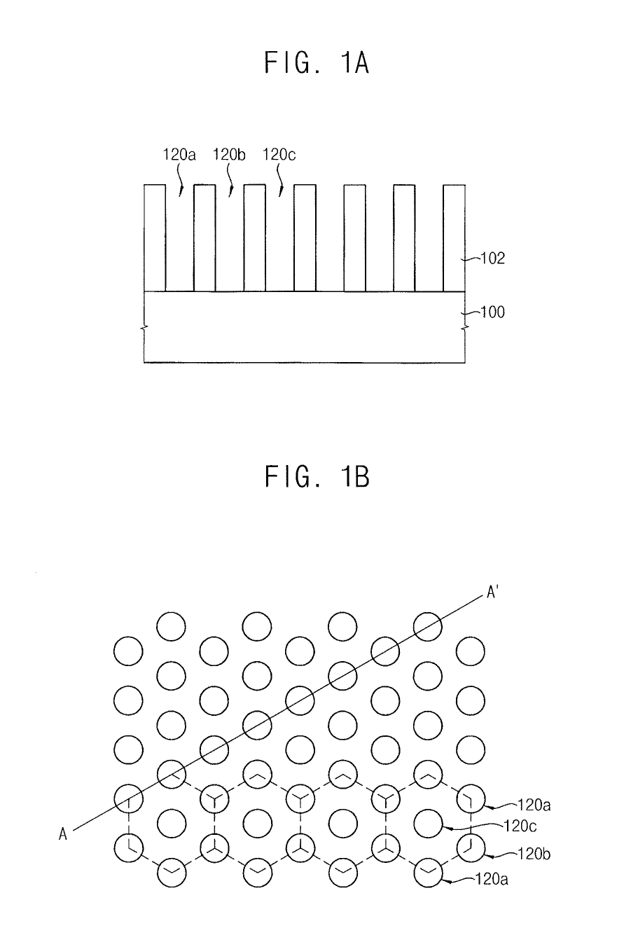

FIG. 1A illustrates a cross-sectional view of a pattern structure in accordance with example embodiments, and FIG. 1B illustrates a plan view of the pattern structure of FIG. 1A. Particularly, FIG. 1A is a cross-sectional view cut along the line A-A′ in FIG. 1B.

Referring to FIGS. 1A and 1B, a mold layer 102 may be formed on a substrate 100 having some structures (not shown) thereon. The mold layer 102 may have a plurality of openings 120a, 120b, and 120c that extend through the mold layer 102, e.g., in its entirety. The plurality of openings 120a, 120b, and 120c may be arranged in a honeycomb structure on the substrate 100. For example, the plurality of openings 120a, 120b, and 120c may form a repeating pattern on the substrate 100.

As shown in FIG. 1B, the openings 120a, 120b, and 120c may together form vertices and centers of hexagon shapes on the substrate 100. The openings 120a, 120b, and 120c may be arranged very closely. In an example embodiment, the hexagons may be regular hexagons. However, embodiments are not limited thereto, e.g., the openings 120a, 120b, and 120c may together form other repeated patterns such as octagon shape, etc. to form the honeycomb shape. The openings 120a, 120b, and 120c may be formed along a plurality of parallel diagonal lines extending across the substrate, e.g., lines that are parallel to line A-A′ in FIG. 1B.

Referring to FIG. 1B, hereinafter for ease of explanation, openings at odd numbered vertices of the hexagons may be referred to as first openings 120a, and openings at even numbered vertices of the hexagons may be referred to as second openings 120b. Further, openings at the centers of the hexagons may be referred to as third openings 120c.

In example embodiments, the first, second and third openings 120a, 120b, and 120c may have substantially the same width or diameter. Distances between the openings 120a, 120b, and 120c may be substantially the same.

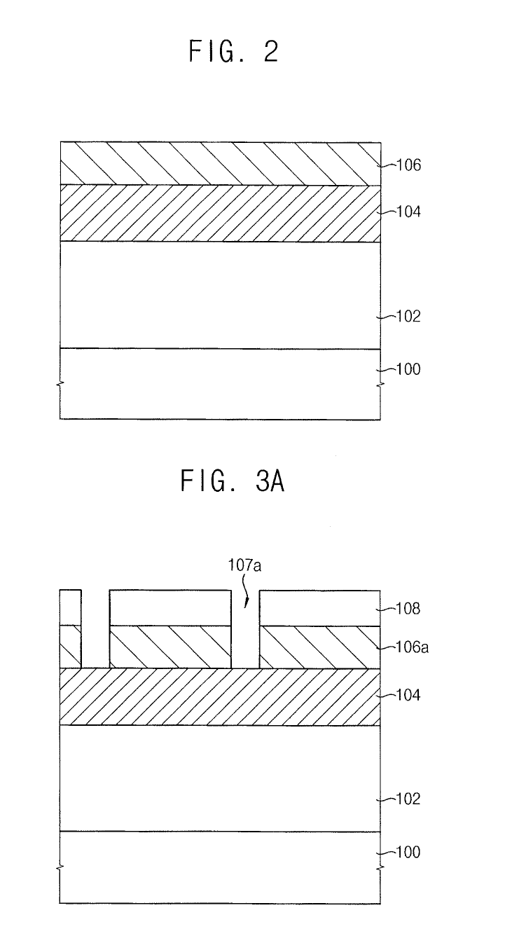

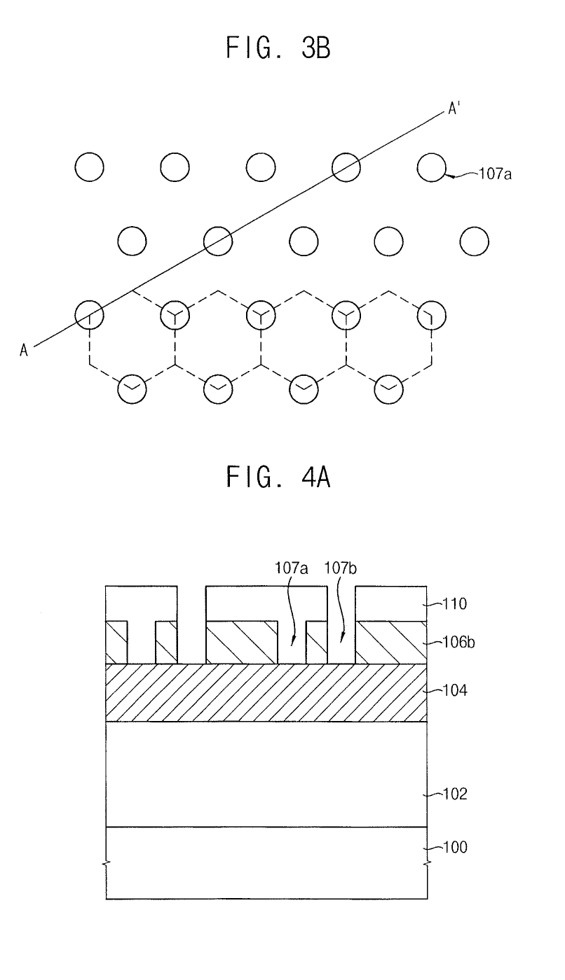

FIGS. 2, 3A, 4A, 5, 6A, 7A, 8A, to 9A illustrate cross-sectional views of stages in a method of forming a pattern structure in accordance with example embodiments, and FIGS. 3B, 4B, 6B, 7B, 8B, and 9B are plan views illustrating the stages in the method of forming the pattern structure.

Referring to FIG. 2, a mold layer 102 may be formed on a substrate 100 having some structures (not shown) thereon. The structures may include transistors, contact plugs, insulating interlayers, and the like. The mold layer may be a single layer or a multilayer having a plurality of stacked layers. For example, the mold layer 102 may be formed using silicon oxide or polysilicon. In the present embodiment, the mold layer 102 may be formed using silicon oxide.

A first hard mask layer 104 may be formed on the mold layer 102. The first hard mask layer 104 may serve as an etching mask for the mold layer 102, and thus may be formed using a material having a high etch selectivity with respect to the mold layer 102. In the present embodiment, the mold layer may include silicon oxide, and the first hard mask layer 104 may be formed using polysilicon.

A second hard mask layer 106 may be formed on the first hard mask layer 104. The second hard mask layer 106 may be formed using a material having a high etch selectivity with respect to the first hard mask layer 104. In example embodiments, the second hard mask layer 106 may be formed using silicon oxide or silicon oxynitride.

Referring to FIGS. 3A and 3B, a first photoresist layer may be formed on the second hard mask layer 106. The first photoresist layer may be patterned by a first photolithography process to form a first photoresist pattern 108.

The second hard mask layer 106 may be etched using the first photoresist pattern 108 as an etching mask to form a preliminary second hard mask 106a. The preliminary second hard mask 106a may have a plurality of first holes 107a extending therethrough, e.g., to expose the first hard mask layer 104. In example embodiments, the first holes 107a may be formed at odd numbered vertices of hexagons, e.g., as illustrated in FIG. 3B. After forming the first holes 107a, the first photoresist pattern 108a may be removed to expose an upper surface of the second hard mask 106a.

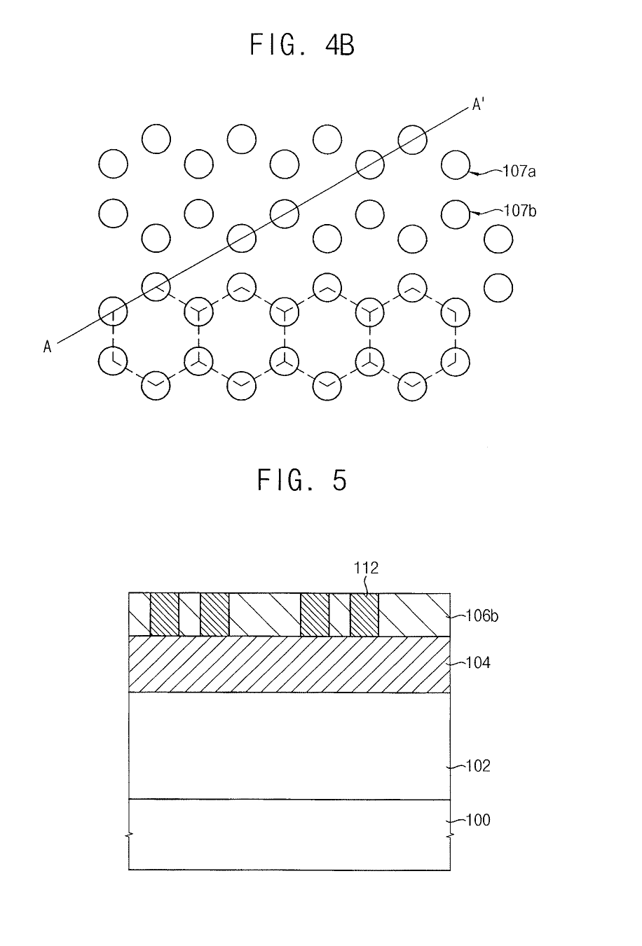

Referring to FIGS. 4A and 4B, a second photoresist layer may be formed on the preliminary second hard mask 106a. The second photoresist layer may be patterned by a second photolithography process to form a second photoresist pattern 110.

The preliminary second hard mask 106a may be etched again using the second photoresist pattern 110 as an etching mask to form a second hard mask 106b. The second hard mask 106b may have a plurality of second holes 107b extending therethrough at even numbered vertices of the hexagons in addition to the first holes 107a at the odd numbered vertices of the hexagons, e.g., as illustrated in FIG. 4B. The second holes 107b may be spaced apart from the first holes 107a. Thereafter, the second photoresist pattern 110 may be removed to expose an upper surface of the second hard mask 106b.

Referring to FIG. 5, a filling layer may be formed on the first hard mask layer 104 and the second hard mask 106b to sufficiently fill, e.g., substantially or completely fill, the first and second holes 107a and 107b. The filling layer may be formed using a material having a high etch selectivity with respect to the second hard mask 106b. For example, the second hard mask 106b includes silicon oxide, and the filling layer may be formed using silicon nitride or silicon oxynitride.

The filling layer may be planarized until a top surface of the second hard mask 106b may be exposed, e.g., by a chemical mechanical polishing (CMP) process and/or by an etch back process, to form filling layer patterns 112 in the first and second holes 107a and 107b.

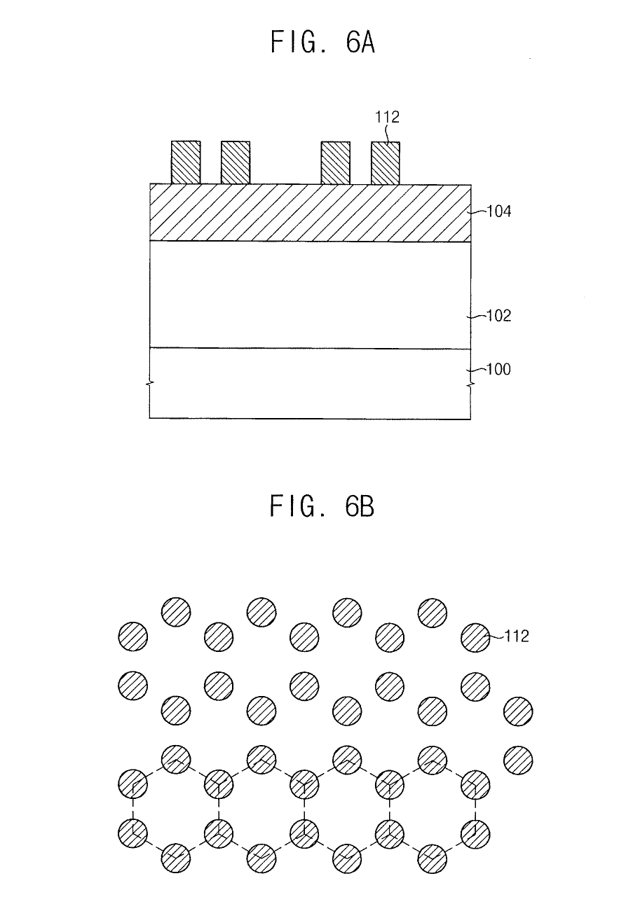

Referring to FIGS. 6A and 6B, the second hard mask 106b may be removed so that the filling layer patterns 112 remain on the first hard mask 104. In example embodiments, the second hard mask 106b may be removed by a wet etching process.

By the above wet etching process, the filling layer patterns 112 having a pillar shape may protrude from the first hard mask layer 104. The filling layer patterns 112 may be located at the vertices, e.g., the odd and the even numbered vertices, of the hexagons.

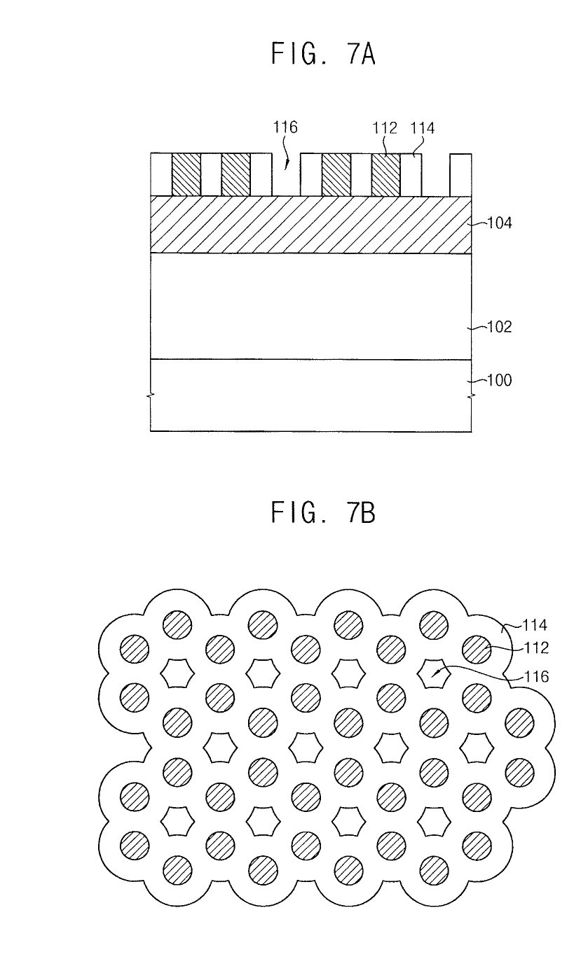

Referring to FIGS. 7A and 7B, a spacer layer may be formed on the filling layer patterns 112 and the first hard mask layer 104. The spacer layer may be formed using a material having a high etch selectivity with respect to the filling layer patterns 112.

The spacer layer may sufficiently fill, e.g., substantially or completely fill, spaces between the filling layer patterns 112 having a relatively short distance therebetween. The spacer layer may also not completely fill, e.g., only partially fill, spaces between the filling layer patterns 112 having a relatively long distance therebetween. In particular, the spacer layer may only partially fill spaces so that center portions of the spaces are not filled, i.e., the first hard mask layer 104 is exposed at the center portions of the spaces. For example, a space between neighboring odd and even numbered vertices of the hexagons may be substantially filled with the spacer layer and a space extending across the hexagons may be partially filled with the spacer layer.

The spacer layer may be anisotropically etched to form a spacer 114 on sidewalls of the filling layer patterns 112, e.g., enclosing lateral sidewalls of each of the filling layer patterns 112. Portions of the top surface of the first hard mask layer 104 may be covered by the spacer 114. Other portions of the top surface of the first hard mask layer 104 may be exposed by third holes 116 that extend through the spacer 114. The third holes 116 may be formed in the space between filling layer patterns 112 having the relatively long distances therebetween. For example, the third holes 116 may be located at centers of the hexagons. The spacer 114 may have a honeycomb structure surrounding the filling layer patterns 112 and having a plurality of the third holes 116 therethrough. In example embodiments, the third holes 116 may have a width or diameter substantially the same as the widths or diameters of the filling layer patterns 112. Further, a shape of the third holes 116 may be substantially the same as the shape of the filling layer patterns 112. Alternatively, the shape of the third holes 116 may be different from the shape of the filling layer patterns 112.

A size of the third holes 115 may be controlled by a thickness of the spacer layer and/or the anisotropical etching process. For example, when the spacer layer is formed to have a greater thickness, the third holes 116 may have a relatively smaller width or diameter.

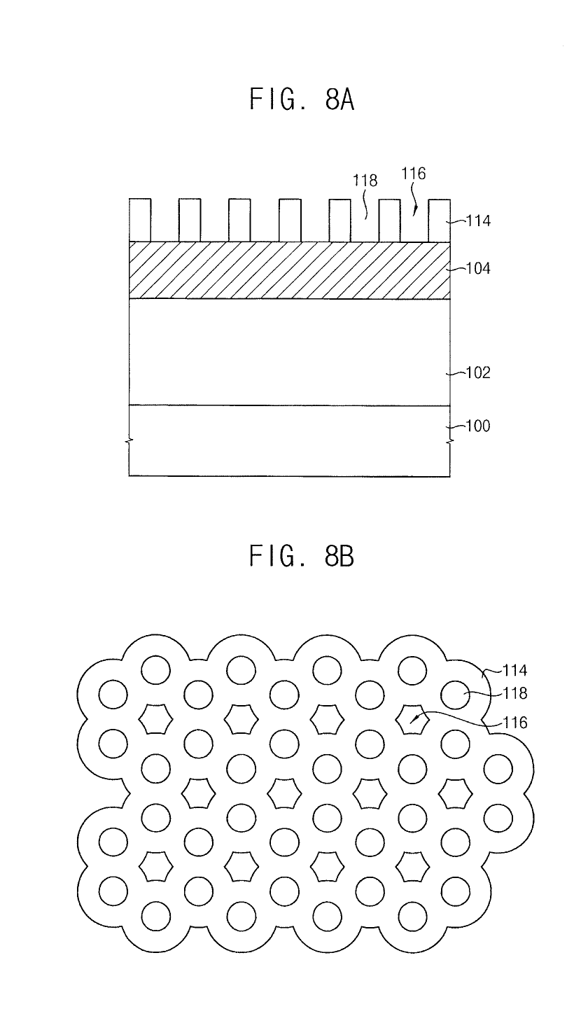

Referring to FIGS. 8A and 8B, the filling layer patterns 112 may be removed to form a plurality of fourth holes 118, e.g., only the spacer 114 may remain on the first hard mask layer 104. Accordingly, the spacer 114 may define each of the plurality of fourth holes 118. The plurality of fourth holes 118 may have a same width or diameter.

As a result, the spacer 114 may have third and fourth holes 116 and 118 therethrough, and the fourth holes 118 may be formed not by a photolithography process but by a wet etching process.

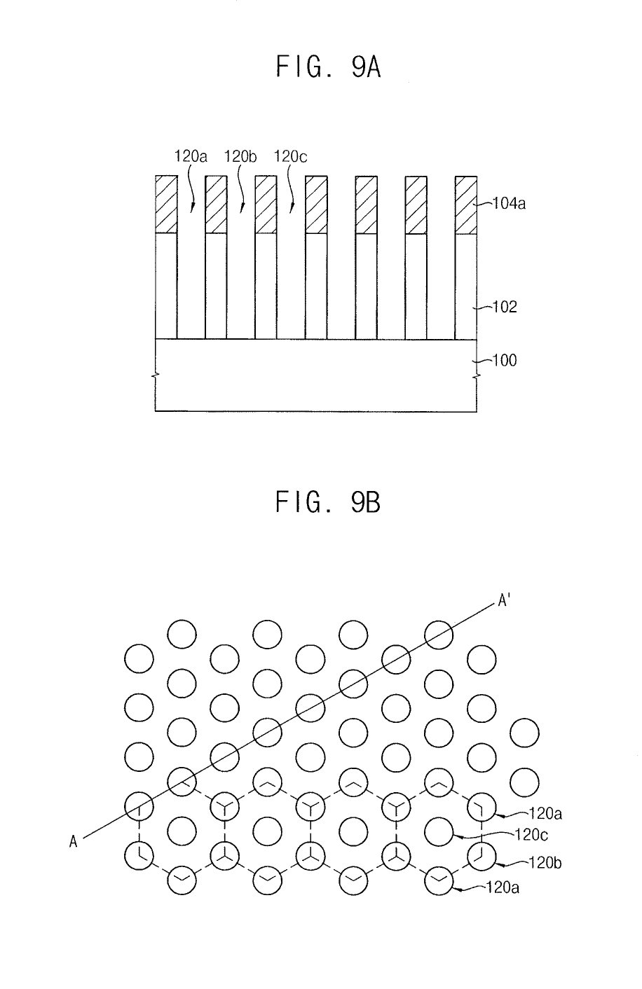

Referring to FIGS. 9A and 9B, the first hard mask layer 104 may be etched using the spacer 114 as an etching mask to form a first hard mask 104a. The mold layer 102 may be etched using the first hard mask 104a as an etching mask. Accordingly, the first, second, and third openings 120a, 120b and 120c, which expose a top surface of the substrate 100, may be formed. The first, second and third openings 120a, 120b and 120c may be formed at the odd numbered vertices, the even numbered vertices, and the centers of the hexagons, respectively.

Thereafter, the first hard mask 104a may be or may not be removed. Accordingly, the first, second, and third openings 120a, 120b, and 120c may extend through the mold layer 102 only or through both the mold layer 102 and the first hard mask 104a.

The openings 120a, 120b, and 120c may be formed very close together, and thus a photolithography process may be performed several times, e.g., three times to form the openings 120a, 120b and 120c. However, as the photolithography process is repeatedly performed, misalignment and process differences may occur so that the openings 120a, 120b, and 120c having a uniform diameter may not be formed.

In contrast, according to example embodiments, the photolithography process may only be performed twice to form the openings 120a, 120b, and 120c in the honeycomb structure, and thereby time and cost may be reduced. Also, the size of the openings, i.e., the third and fourth openings 116 and 118 may be controlled by a thickness of the spacer layer, so that process differences may be reduced. Further, the openings 120a, 120b, and 120c may be formed at the vertices and the centers of the hexagons, and thus the openings 120a, 120b, and 120c may be arranged regularly on the substrate 100.

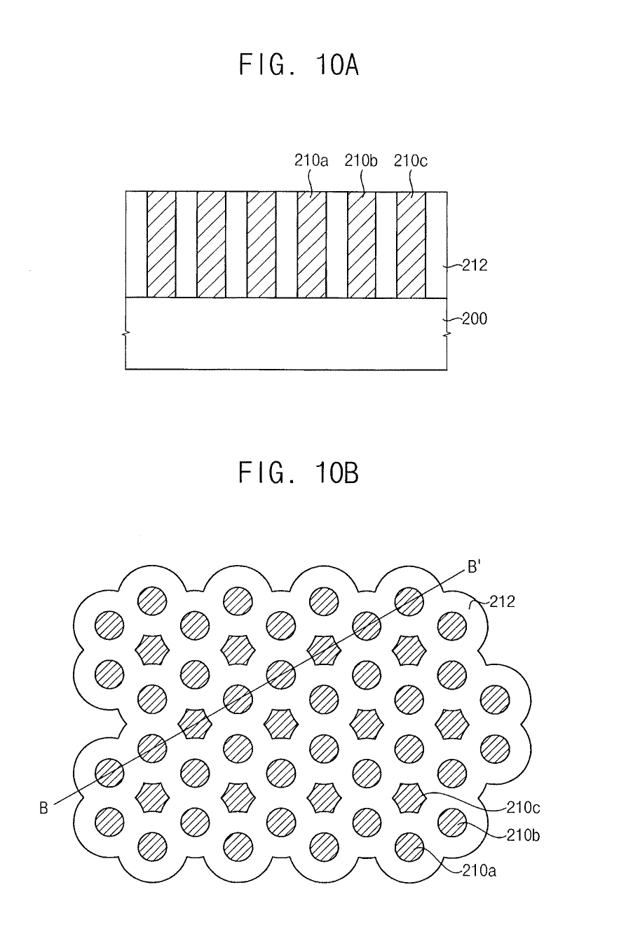

FIG. 10A illustrates a cross-sectional view of a pattern structure in accordance with example embodiments, and FIG. 10B illustrates a plan view of the pattern structure of FIG. 10A. Particularly, FIG. 10A illustrates a cross-sectional view cut along the line B-B′ in FIG. 10B.

Referring to FIGS. 10A and 10B, a plurality of patterns 210a, 210b, and 210c may be formed on a substrate 200. Sidewalls of the patterns 210a, 210b, and 210c may be surrounded, e.g., completely surrounded, by an insulating interlayer 212.

The patterns 210a, 210b, and 210c may include a conductive material. The patterns 210a, 210b, and 210c may serve as pad electrodes. The patterns 210a, 210b, and 210c may have a honeycomb structure, e.g., as illustrated in FIG. 10B.

As shown in FIG. 10B, the patterns 210a, 210b, and 210c may be arranged at vertices and centers of hexagons, and may be arranged very closely.

Hereinafter, patterns at odd numbered vertices of hexagons are referred to as first patterns 210a and patterns at even numbered vertices of hexagons are referred to as second patterns 210b. Further, patterns at centers of hexagons are referred to as third patterns 210c.

In example embodiments, the first and second patterns 210a and 210b may have substantially the same shape, and the third patterns 210c may have a different shape from the first and second patterns 210a and 210b. Distances between the patterns 210a, 210b, and 210c may be substantially the same.

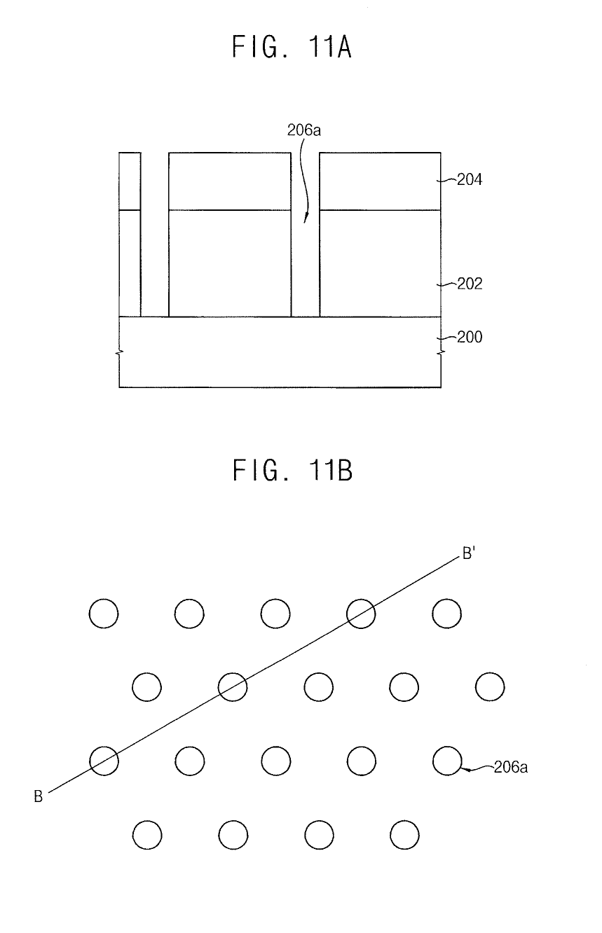

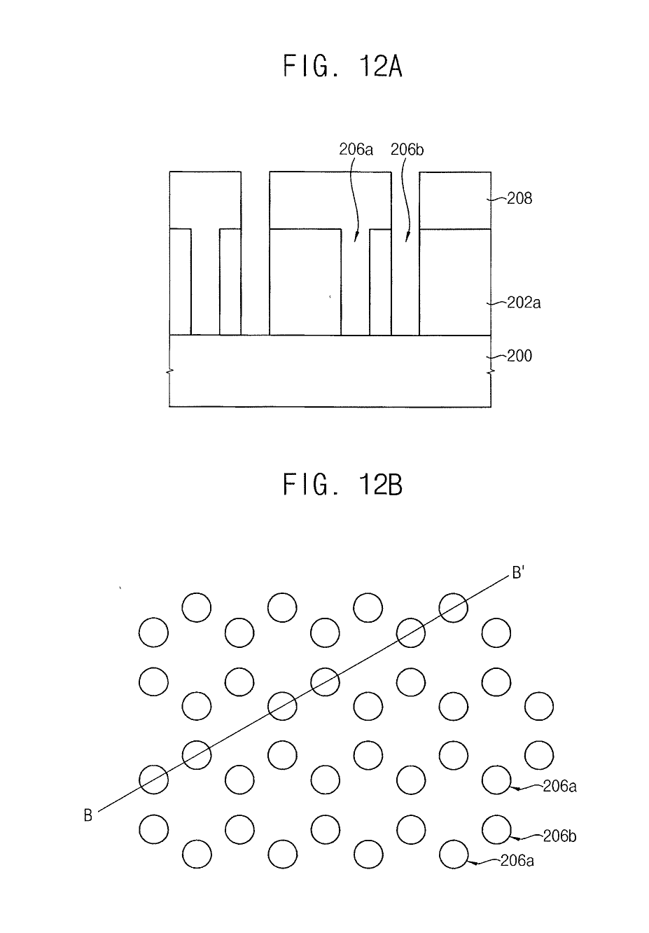

FIGS. 11A to 14A illustrate cross-sectional views depicting stages in a method of forming a pattern structure in accordance with example embodiments, and FIGS. 11B to 14B illustrate plan views depicting stages in the method of forming the pattern structure.

Referring to FIGS. 11A and 11B, a sacrificial layer may be formed on a substrate 200.

A first photoresist layer may be formed on the sacrificial layer, and the first photoresist layer may be patterned to form a first photoresist pattern 204.

The sacrificial layer may be etched using the first photoresist pattern 204 as an etching mask to form preliminary sacrificial layer pattern 202. The preliminary sacrificial layer pattern 202 may have first holes 206a extending therethrough. In example embodiments, the first holes 206a may be located at odd numbered vertices of hexagons. Then, the first photoresist pattern 204 may be removed.

Referring to FIGS. 12A and 12B, a second photoresist layer may be formed on the preliminary sacrificial layer pattern 202, and patterned to form a second photoresist pattern 208.

The preliminary sacrificial layer pattern 202 may be etched again using the second photoresist pattern 208 as an etching mask to from sacrificial layer pattern 202a. The sacrificial layer pattern 202a may further include second holes 206b located at even numbered vertices of the hexagons in addition to the first holes 206a at the odd numbered vertices of the hexagons. The second holes 206b may be spaced apart from the first holes 206a. Then, the second photoresist pattern 208 may be removed.

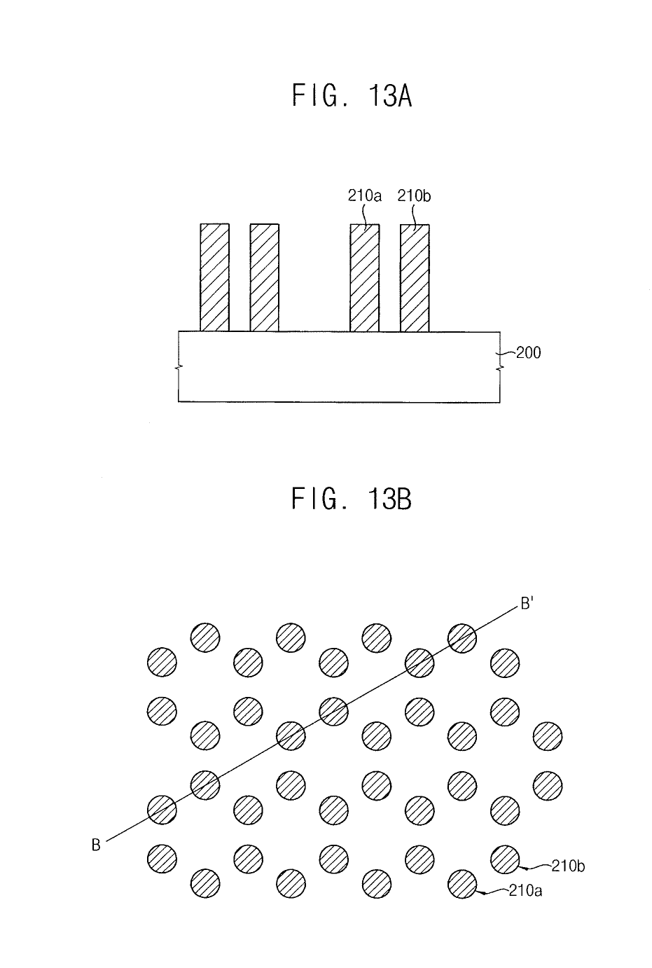

Referring to FIGS. 13A and 13B, a first conductive layer may be formed on the substrate 200 and the sacrificial layer pattern 202a to sufficiently, e.g., substantially or completely, fill each of the first and second holes 206a and 206b.

The first conductive layer may be planarized until a top surface of the sacrificial layer pattern 202a may be exposed by a CMP process and/or by an etch back process to form first and second patterns 210a and 210b in the first and second holes 206a and 206b, respectively. The sacrificial layer pattern 202a may be removed. In example embodiments, the sacrificial layer pattern 202a may be removed by a wet etching process.

By the above wet etching process, the first and second patterns 210a and 210b having a pillar shape may protrude from the substrate 200. The first and second patterns 210a and 210b may be located at the vertices of the hexagons.

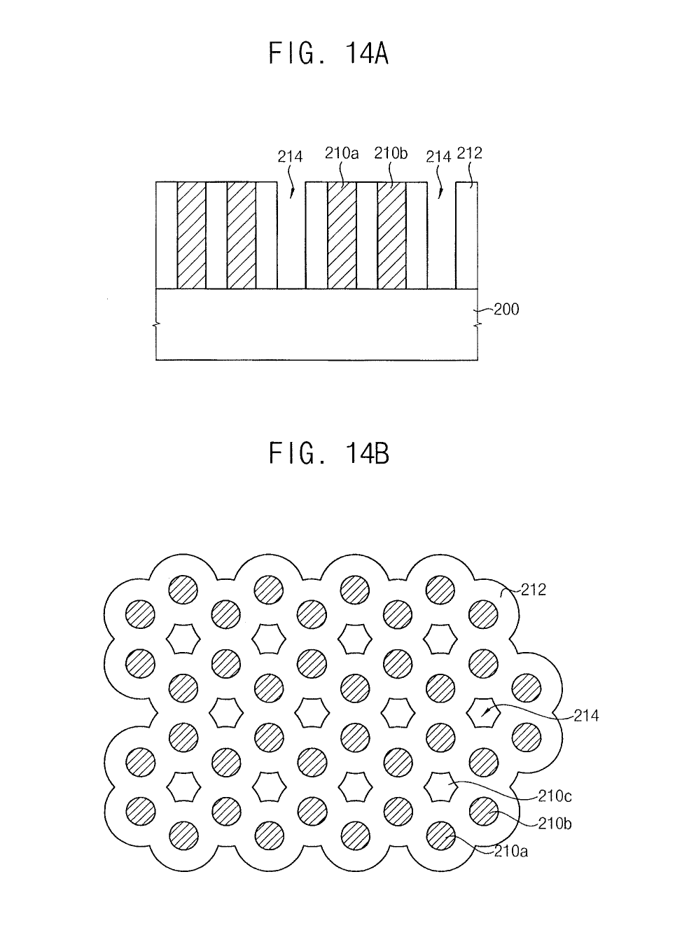

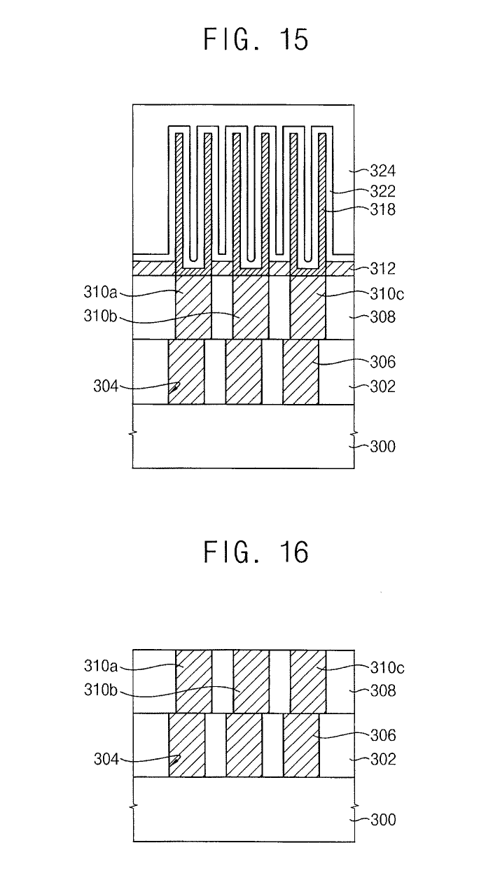

Referring to FIGS. 14A and 14B, a spacer layer may be formed on the first and second patterns 210a and 210b and the substrate 200. The spacer layer may be formed using an insulating material.

The spacer layer may sufficiently fill, e.g., substantially fill or completely fill, spaces between the first and second patterns 210a and 210b having a relatively short distance therebetween. The spacer layer may not completely fill, e.g., may only partially fill, spaces between the first and second patterns 210a and 210b having a relatively long distance therebetween.

The spacer layer may be anisotropically etched to form a spacer 212 on sidewalls of the first and second patterns 210a and 210b, and a top surface of the substrate 200 may be exposed. The spacer 212 may be formed using a method the same as or substantially similar to the method used to form the spacer 114. The spacer 212 may have a honeycomb structure surrounding the first and second patterns 210a and 210b and having a plurality of third holes 214 therethrough. The third holes 214 may be located at centers of the hexagons. In example embodiments, the third holes 214 may have a diameter substantially the same as that of the first and second patterns 210a and 210b.

Referring to FIGS. 10A and 10B again, a second conductive layer may be formed on the substrate 200 and the first and second patterns 210a and 210b to sufficiently, e.g., substantially or completely, fill the third holes 214. In example embodiments, the second conductive layer may be formed using a material substantially the same as that of the first conductive layer. The second conductive layer may be planarized until a top surface of the first and second patterns 210a and 210b may be exposed to form third patterns 210c.

By the above processes, the first, second and third patterns 210a, 210b, and 210c having a honeycomb structure and being arranged very closely may be formed.

According to example embodiments, a photolithography process may only be performed twice to form the patterns 210a, 210b, and 210c in the honeycomb structure, and thus time and cost for forming patterns using the photolithography process may be reduced.

Various types of semiconductor devices may be manufactured using the above methods of forming openings and/or patterns. For example, capacitors may be formed using the method of forming openings. Additionally, pad electrodes may be formed using the method of forming patterns. Hereinafter, semiconductor devices and methods of manufacturing the semiconductor devices may be illustrated using the above methods.

FIG. 15 illustrates a cross-sectional view of capacitors in accordance with example embodiments.

Referring to FIG. 15, capacitors may contact pad electrodes 310a, 310b, and 310c. Each capacitor may include a lower electrode 318, a dielectric layer 322, and an upper electrode 324.

A first insulating interlayer 302 may be formed on a substrate 300. Some structures (not shown), e.g., selection transistors, wirings connected to the selection transistors, etc., may be formed on the substrate 300. A plurality of contact plugs 306 may be formed through the first insulating interlayer 302 and be in contact with top surfaces of the substrate 300 and/or the wirings. In example embodiments, the contact plugs 306 may be arranged regularly.

A second insulating interlayer 308 may be formed on the first insulating interlayer 302. The pad electrodes 310a, 310b, and 310c, which may extend through the second insulating interlayer 308, may make contact with the contact plugs 306 and may be formed on the first insulating interlayer 302. The pad electrodes 310a, 310b, and 310c may have an island shape from each other, e.g., so as to be spaced apart from each other. The pad electrodes 310a, 310b, and 310c may be located at vertices and centers of hexagons in a honeycomb structure.

The pad electrodes 310a may be located at odd numbered vertices of the hexagons and are referred to as first pad electrodes 310a. The pad electrodes 310b may be located at even numbered vertices of the hexagons and are referred to as second pad electrodes 310b. The pad electrodes 310c may be located at centers of the hexagons and are referred to as third pad electrodes 310c.

Sidewalls of the pad electrodes 310a, 310b, and 310c may be surrounded by, e.g., completely enclosed by, the second insulating interlayer 308. An etch stop layer 312 may be formed on the second insulating interlayer 308. The etch stop layer 312 may extend to be formed be on the pad electrodes 310a, 310b, and 310c.

The lower electrodes 318 may be formed on the pad electrodes 310a, 310b and 310c, and formed to have a cylindrical shape. The lower electrodes 318 may make direct contact with the pad electrodes 310a, 310b, and 310c, e.g., each of the lower electrodes 318 may be make direct contact with one of the pad electrodes 310a, 310b, and 310c. The lower electrodes 318 may be arranged in substantially the same manner as the pad electrodes 310a, 310b and 310c, and thus may have a honeycomb structure.

The dielectric layer 322 may be formed on the lower electrodes 318 and the etch stop layer 312. The upper electrode 324 may be formed on the dielectric layer 322.

The capacitors may have a cylindrical shape and may be arranged closely in a honeycomb structure. Thus, a lot of capacitors may be formed in a small area.

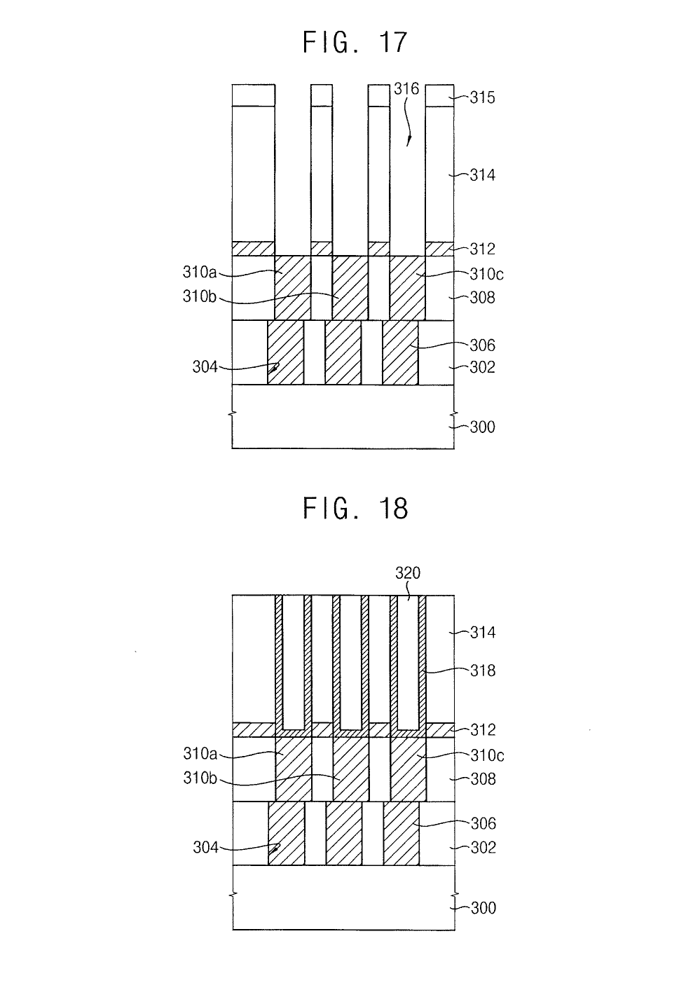

FIGS. 16 to 19 illustrate cross-sectional views depicting stages in a method of forming capacitors in accordance with example embodiments.

Referring to FIG. 16, a first insulating interlayer 302 may be formed on a substrate 300. The first insulating interlayer 302 may be partially etched to form a plurality of contact holes 304 exposing top surfaces of the substrate 300.

A conductive material may be filled into the contact holes 304 and an upper portion of the conductive material may be planarized to form a plurality of contact plugs 306. Before forming the first insulating interlayer 302, transistors (not shown) and wirings (not shown) may be formed on the substrate 300.

A first sacrificial layer may be formed on the first insulating interlayer 302 and the contact plugs 306. The first sacrificial layer may be partially etched to form a sacrificial layer pattern having first and second holes exposing the contact plugs 306.

A first photolithography process may be performed to form a preliminary sacrificial layer pattern having first holes, and a second photolithography process may be performed to form a sacrificial layer pattern further having second holes in addition to the first holes. The first and second photolithography processes may be substantially the same as those illustrated with reference to FIGS. 11A and 12A.

A first conductive layer may be filled into the first and second holes, and an upper portion of the first conductive layer may be planarized to form the first and second pad electrodes 310a and 310b.

After removing the sacrificial layer pattern, a spacer layer may be formed on the first and second pad electrodes 310a and 310b, the first insulating interlayer 302, and the contact plugs 306. The spacer layer may be anisotropically etched to form a spacer 308 having third holes exposing the contact plugs 306. The spacer 308 may serve as an insulating interlayer that may insulate the pad electrodes 310a and 310b from each other, and referred to as the second insulating interlayer 308, hereinafter.

A second conductive layer may be filled into the third holes, and an upper portion of the second conductive layer may be planarized to form third pad electrodes 310c.

The processes for forming the first, second, and third pad electrodes 310a, 310b, and 310c may be substantially the same as those illustrated with reference to, e.g., FIGS. 13A, 14A and 10B. Thus, the first, second and third pad electrodes 310a, 310b, and 310c may be arranged at vertices and centers of hexagons in a honeycomb structure.

Referring to FIG. 17, an etch stop layer 312 may be formed on the second insulating interlayer 208 and pad electrodes 310a, 310b, and 310c. A mold layer 314 may be formed on the etch stop layer 312.

A first hard mask 315 may be formed on the mold layer 314. The mold layer 314 and the etch stop layer 312 may be etched using the first hard mask 315 as an etching mask, so that openings 316 exposing the pad electrodes 310a, 310b, and 310c may be formed.

The process for forming the openings 316 in the mold layer 314 may be substantially the same as that illustrated with reference to, e.g., FIGS. 3A to 9A.

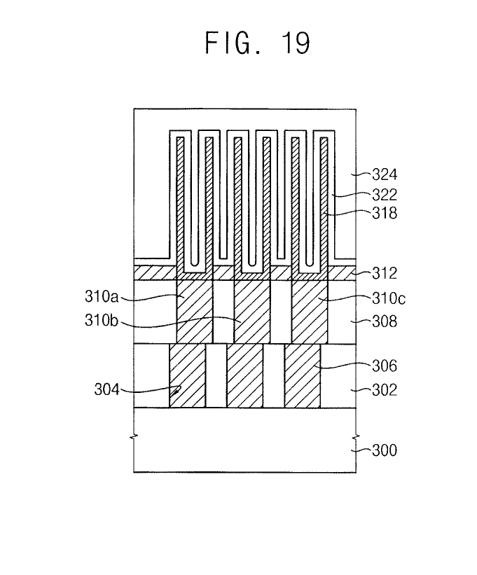

Referring to FIG. 18, a lower electrode layer may be formed on the exposed pad electrodes 310a, 310b, and 310c, inner walls of the openings 316 and the first hard mask 315.

A second sacrificial layer 320 may be formed on the lower electrode layer to sufficiently fill the openings 316. The second sacrificial layer 320 may be formed using a material substantially the same as that of the mold layer 314.

Upper portions of the second sacrificial layer 320 and the lower electrode layer may be planarized until a top surface of the mold layer 314 may be exposed, and the first hard mask 315 may be also removed in the planarization process. Thus, a plurality of lower electrodes 318 may be formed.

Referring to FIG. 19, the mold layer 314 and the second sacrificial layer 320 may be removed. In example embodiments, the removal may be performed by a wet etching process.

A dielectric layer 322 may be formed on the lower electrodes 318 and the etch stop layer 312. An upper electrode 324 may be formed on the dielectric layer 322 using a metal, a metal nitride, a metal silicide, a doped polysilicon, and/or the like. Thus, capacitors having a honeycomb structure may be formed.

According to example embodiments, the pad electrodes 310a, 310b, and 310c in a honeycomb structure may be formed by performing a photolithography process twice. The pad electrodes 310a, 310b, and 310c may be arranged at positions substantially the same as those of the lower electrodes 318, and thus the misalignment between the pad electrodes 310a, 310b, and 310c and the corresponding ones of the lower electrodes 318 may be reduced.

According to example embodiments, openings or patterns in a honeycomb structure may be formed, which may be used in manufacturing various types of semiconductor devices. Example embodiments relate to methods of forming pattern structures. More particularly, example embodiments relate to methods of forming openings or patterns arranged in a honeycomb structure.

By way of summation and review, as semiconductor devices have been highly integrated, openings or patterns may be formed very closely, and the size of the openings or patterns may decrease. Thus, forming openings or patterns at a desired position with a desired size is not easy, and adjacent openings or patterns may be undesirably connected. Further, the openings or patterns may not be exactly aligned with lower patterns or structures.

When forming a plurality of openings and/or patterns very close to each other, undesired bridges and/or misalignments may occur. For example, when forming the openings and/or patterns by a photolithography process, the photolithography process may have to be performed at least three times. As the number of the photolithography process increases, misalignments may occur more frequently.

In contrast, according to exemplary embodiments, first holes at odd numbered vertices of hexagons may be formed through a mask layer to form a preliminary mask, and second holes at even numbered vertices of the hexagons may be formed through the preliminary mask to form a mask. After filling the first and second holes to form first and second filling layer patterns and removing the mask, a spacer layer may be formed on sidewalls of the first and second filling layer patterns. The spacer layer may be anisotropically etched to form a spacer having third holes at centers of the hexagons. Thus, an underlying layer may be etched using the spacer as an etching mask to form a plurality of openings, which openings may be arranged in a repeating pattern at the vertices and the centers of the hexagons. The openings may be simply and exactly formed by performing a photolithography process only twice.

According to example embodiments, a plurality of openings and/or patterns having a honeycomb structure may be formed by simple processes. When the openings and the patterns are formed, misalignment may be reduced. By the method of forming the openings and the patterns, capacitors may be formed at a low cost.

Example embodiments provide a method of forming openings arranged in a honeycomb structure. Example embodiments provide a method of forming patterns arranged in a honeycomb structure. Example embodiments provide a method of forming capacitors arranged in a honeycomb structure.

Example embodiments have been disclosed herein, and although specific terms are employed, they are used and are to be interpreted in a generic and descriptive sense only and not for the purpose of limitation. In some instances, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of manufacturing a pattern structure, the method comprising:
sequentially forming a mold layer and a mask layer on a substrate;
patterning the mask layer to form a mask having a plurality of first and second holes located at vertices of hexagons that form a honeycomb structure;
forming filling layer patterns in the first and second holes;
removing the mask;
forming a spacer on sidewalls of the filling layer patterns, the spacer having a plurality of third holes at centers of the hexagons;
removing the filling layer patterns to form an etching mask including the spacer; and
etching the mold layer using the etching mask to form the pattern structure having a plurality of openings located at the vertices and the centers of the hexagons.

2. The method as claimed in claim 1, wherein a size of the third holes is controlled by a thickness of the spacer.

3. The method as claimed in claim 1, further comprising forming a hard mask layer between the mold layer and the mask layer.

4. The method as claimed in claim 1, wherein the mask is formed by performing a photolithography process twice.

5. The method as claimed in claim 4, wherein forming the mask includes:
performing a first photolithography process on the mask layer to form a preliminary mask having the first holes at odd numbered vertices of the hexagons; and
performing a second photolithography process on the preliminary mask to form the mask having the second holes at even numbered vertices of the hexagons in addition to the first holes.

6. The method as claimed in claim 5, wherein forming the spacer includes:
forming a spacer layer on the filling layer patterns and the mold layer; and
anisotropically etching the spacer layer.

7. A method of manufacturing a capacitor, the method comprising:
manufacturing the pattern structure according to the method claimed in claim 1, wherein the honeycomb structure is a first honeycomb structure having first hexagons including first vertices and first centers;
forming a plurality of lower electrodes in the openings;
sequentially foaming a dielectric layer and an upper electrode on the lower electrodes; and
forming pad electrodes on the substrate prior to manufacturing the pattern structure, the pad electrodes being arranged at second vertices and second centers of second hexagons that form a second honeycomb structure.

8. The method as claimed in claim 7, wherein forming the pad electrodes includes:
forming a sacrificial layer on the substrate;
patterning the sacrificial layer to form a sacrificial layer pattern having a plurality of fourth and fifth holes located at the first vertices of the first hexagons forming the first honeycomb structure;
forming first and second pad electrodes in the fourth and fifth holes, respectively;
removing the sacrificial layer pattern;
forming a second spacer on sidewalls of the first and second pad electrodes, the second spacer having a plurality of sixth holes at the first centers of the first hexagons; and
forming third pad electrodes in the sixth holes.

9. The method as claimed in claim 7, wherein a size of the third holes is controlled by a thickness of the spacer.

10. The method as claimed in claim 7, further comprising forming an etch stop layer on the pad electrodes.

11. The method as claimed in claim 7, further comprising removing the mold layer to expose sidewalls of the lower electrodes after forming the lower electrodes.

12. The method as claimed in claim 7, wherein patterning the mask layer includes performing a photolithography process twice.

13. A method of manufacturing a pattern structure, comprising:
forming a sacrificial layer on a substrate;
patterning the sacrificial layer to form a sacrificial layer pattern having a plurality of first and second holes located at vertices of hexagons that form a honeycomb structure;
forming first and second conductive layers in the first and second holes, respectively;
removing the sacrificial layer pattern;
forming a spacer on sidewalls of the first and second conductive layers, the spacer having a plurality of third holes at centers of the hexagons; and
forming third conductive layers in the third holes.

14. The method of claim 13, wherein the sacrificial layer pattern is formed by performing a photolithography process twice.

15. The method of claim 13, wherein forming the sacrificial layer pattern includes:
performing a first photolithography process on the sacrificial layer to form a preliminary sacrificial layer pattern having the first holes at odd numbered vertices of the hexagons; and
performing a second photolithography process on the preliminary sacrificial layer pattern to form the sacrificial layer pattern having the second holes at even numbered vertices of the hexagons in addition to the first holes.

16. A method of manufacturing a pattern structure, the method comprising:
forming a mask layer on a substrate, the mask layer including a plurality of first and second holes corresponding to vertices of hexagons;
filling the first and second holes of the mask layer;
removing the mask layer after filling the first and second holes such that filling layer patterns corresponding to the first and second holes remain on the substrate;
forming a spacer covering sidewalls of the filling layer patterns, the spacer including third holes therein;
removing the filling layer patterns such that the spacer remains on the substrate to form an etching mask having a honeycomb structure; and
forming the pattern structure using the etching mask.

17. The method as claimed in claim 16, wherein the etching mask has a plurality of openings corresponding to the first, the second, and the third holes, respectively, the plurality of openings being spaced apart from each other.

18. The method as claimed in claim 16, wherein a photolithography process is only performed twice to form the etching mask.

19. The method as claimed in claim 18, wherein the photolithography process includes a first photolithography process that forms the first holes and a second photolithography process that forms the second holes.

20. The method as claimed in claim 19, wherein the third holes correspond to centers of the hexagons, the centers of the hexagon being spaced apart from the vertices of the hexagons in the honeycomb structure.
